(19) United States
(12) Patent Application Publication
(10) Pub. No.: US 2008/0202303 A1
(43) Pub. Date: Aug. 28, 2008

(54) DESK-TOP CUTTING MACHINE

(76) Inventors: Ryuuichi Imamura, Ibaraki (JP); Kouji Takase, Ibaraki (JP); Hiromi Ozawa, Ibaraki (JP); Masayuki Tajima, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/940,807

(22) Filed: Nov. 15, 2007

(30) Foreign Application Priority Data
Nov. 16, 2006 (JP) P2006-309856

(51) Int. Cl. B27B 5/26; B27B 5/36

(52) U.S. Cl. 83/468.3; 83/471.3; 83/477.2

(57) ABSTRACT

The invention provides a desk-top cutting machine including a turntable on a upper surface of which a wood material can be placed, a fence part which is provided on the turntable and has a side surface for positioning the wood material, and a cutting part having a swinging shaft part which is disposed on the turntable, supports a cutting blade up of the turntable, and swings the cutting blade approachably to and separably from the turntable. Herein, on the upper surface and the side surface, recess portions are formed, and plate materials which cover the recess portions are provided.

### CROSS-REFERENCE TO RELATED APPLICATIONS

This application is based on and claims the benefit of priority from the prior Japanese Patent Application No. 2006-309856, filed on Nov. 16, 2006; the entire contents of which are incorporated herein by reference.

### BACKGROUND

1. Technical Field

The present invention relates to a desk-top cutting machine.

2. Description of Related Art

Heretofore, in a desk-top cutting machine, a table of a base part on which a workpiece such as a wood material is placed, and a fence which is provided on the base part and performs positioning of the workpiece have been molded by casting aluminum material. A table upper surface and a fence side surface which are contact surfaces where the fence and the table come into contact with the workpiece are shaved, in order to secure cutting accuracy of the workpiece, by machining after casting, and the fence and the table are molded. (e.g. Please see JP-A-2000-3179901.)

### SUMMARY

In the molding time of the base part, a bubble is produced inside the vicinity of its surface. In case the surface of the base part where this air bubble is produced is shaved to form the table upper surface, a hole-shaped casting defect, that is, a “cavity” occurs on the surface. This “cavity” cannot be confirmed before machining, and can be firstly confirmed after machining. In case that a workpiece is placed and moved on the table upper in which the “cavity” is produced, the workpiece is damaged by a sharp edge formed around the “cavity” and a dropped-out broken piece. Accordingly, the table and the fence in which the “cavity” is produced cannot be used as a product, and cannot help being discarded, so that yield is worsened. Further, since poor machining occurs after machining, productivity is worsened very much.

Therefore, an object of the invention is to provide a desk-top cutting machine which suppresses occurrence of “cavity” to improve quality of a product, and increases productivity.

In order to solve the above problems, the invention provides a desk-top cutting machine including a base part which can place a workpiece on its upper surface; a fence part which is provided on the base part and has a side surface for positioning the workpiece; and a cutting part which can swing a cutting blade approachably to and separably from the base part. Herein, a plate material is provided on at least one of the upper surface and the side surface, and in a contactable position with the workpiece.

According to such the constitution, the portion which comes into contact with the workpiece can be formed of the plate material which is a separate member from the base part and the fence part. Therefore, even if the “cavity” is produced in the base part or the like, it is prevented that the workpiece is damaged. Further, since the plate material can be formed of the separate member from the base part and the fence part, in case that the plate material has been damaged, only the plate material can be exchanged.

In the thus constructed desk-top cutting machine, it is preferable that a recess portion is provided for at least one of the upper surface and the side surface, and the plate material has a portion arranged in the recess portion. According to such the constitution, since space closed by the plate material can be formed in the recess portion, an object can be housed in this space.

Further, it is preferable that: a step part which comes into contact with the plate material is formed in the recess portion; and a distance from the contact portion of the step part with the plate material to the upper surface or the side surface is formed larger than a thickness of the plate material.

According to such the constitution, it is suppressed that the plate material protrudes from the upper surface of the base part and the side surface of the fence part. Therefore, portions protruding from the upper surface and the side surface are not formed, so that the workpiece can be placed appropriately on the base part and the fence part.

Further, it is preferable that: the plate material is fixed to the step part by a screw; and a head of the screw caves in a surface of the plate material.

According to such the constitution, it is possible to facilitate attachment and detachment of the plate material in relation to the base part and the fence part. Further, since the head of the screw caves in the surface of the plate material, it does not protrude from the surface of the plate material. Therefore, it is restrained that the head of the screw comes into contact with the workpiece.

Further, it is preferable that the plate material is formed of a transparent material. According to such the constitution, an object housed in the recess portion can be visually recognized through the plate material.

### Advantage of the Invention

According to the desk-top cutting machine of the invention, it is possible to suppress occurrence of a “cavity” to improve quality of a product, and increase productivity.

### BRIEF DESCRIPTION OF THE DRAWINGS

In the accompanying drawings:

FIG. 1 is a perspective view of a desk-top cutting machine according to an embodiment of the invention;

FIG. 2 is a side view of the desk-top cutting machine according to the embodiment of the invention;

FIG. 3 is a sectional view taken along a line III-III of FIG. 1;

FIG. 4 is a sectional view taken along a line IV-IV of FIG. 1;

FIG. 5 is a sectional view taken along a line V-V of FIG. 1;

FIG. 6 is a front view of the desk-top cutting machine according to the embodiment of the invention;

FIG. 7 is a back view of the desk-top cutting machine according to the embodiment of the invention; and

FIG. 8 is a sectional view of a turntable according to a modified example of the embodiment of the invention.

### DESCRIPTION OF THE EMBODIMENT

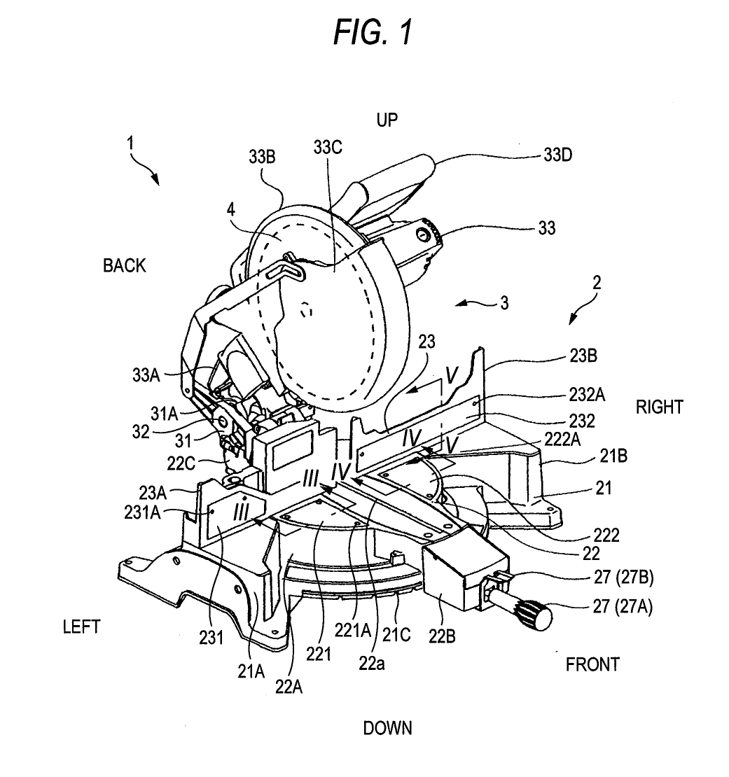

A desk-top cutting machine according to an embodiment of the invention will be described with reference to FIGS. 1 to 8. A desk-top circular sawing machine 1 which is a desk-top cutting machine, shown in FIG. 1 includes a rotating mechanism and a tilt mechanism, and is mainly composed of a base part 2 and a cutting part 3.

The base part 2 is mainly composed of a base 21 which carries and supports a wood material W that is a workpiece to be cut, a turntable 22 which is rotatably carried and supported on the base 21, and a fence 23 provided for the base 21. The base 21 is composed of a pair of left base 21A and right base 21B. A direction where these left base 21A and right base 21B are arranged in a row is defined as a left-right direction, an upper side of the base 21 surface on which the wood material W is placed is defined as “up”, and an opposite side to the “up” is defined as “down”. Between the left base 21A and the right base 21B, there is provided an arcuate part 21C which is formed nearly arcuately and connects the left base 21A and the right base 21B.

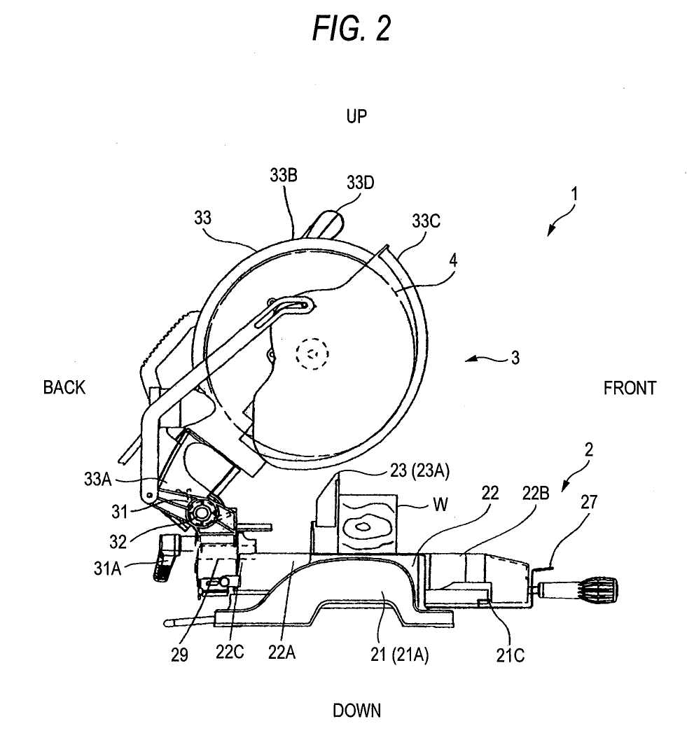

The turntable 22 is carried and supported on the base 21 through a not-shown rotating shaft part, arranged between the right base 21B and the left base 21A, and constituted so that its upper surface becomes the same plane as an upper surface of the base 21. As shown in FIGS. 1 and 2, the turntable 22 is composed of a turntable body portion 22A formed in the shape of a nearly circular base, a base portion 22B which protrudes to one side of the turntable body portion 22A and is arranged over the arcuate part 21C, and a cutting part supporting portion 22C which is provided on the other side of the turntable body portion 22A and supports the cutting part 3. A direction in which this base portion 22B protrudes from the turntable 22 and which is orthogonal to the left-right direction is defined as a front direction, and a direction opposite to the front direction is defined as a back direction.

On the upper surface of the turntable 22, as shown in FIG. 1, a groove portion 22a is continuously formed from a position near the cutting part supporting portion 22C to the base portion 22B. This groove portion 22a is arranged on the not-shown rotating shaft portion, and located in the same position as an intersection position when a later-described cutting blade 4 swings downward and intersects the turntable 22. In this groove portion 22a, a blade edge of the cutting blade 4 is housed.

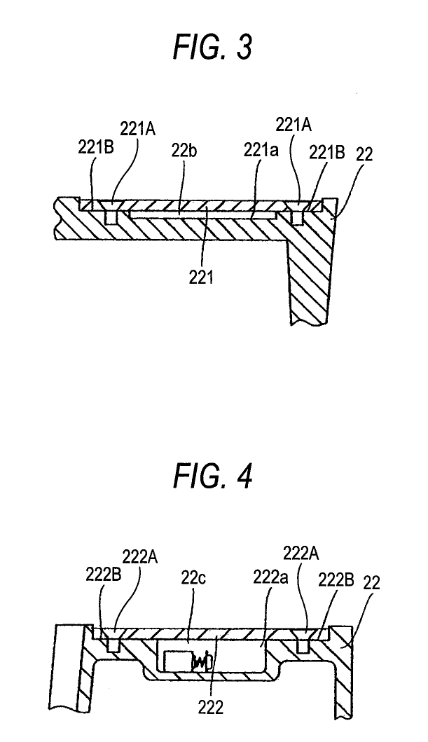

On the upper surface of the turntable 22, on a left upper surface and a right upper surface with the groove portion 22a between, a plate material 221 and a plate material 222 are fixed respectively by screws 221A and screws 222A. The plate material 221 and the plate material 222 are respectively formed of a transparent resin such as acryl or polycarbonate as base material. On the upper surface of the turntable 22 to which this plate material 221 is fixed, as shown in FIG. 3, a recess portion 221a is formed, and the plate material 221 is arranged in the recess portion 221a.

A portion of the turntable 22 which defines the recess portion 221a is provided with a step part 221B in which a screw hole is formed, and the plate material 221 is arranged on this step part 221B and fixed by the screws 221A. The step part 221B is formed so that a distance from a contact surface of the step part 221B with the plate material 221 to the upper surface of the turntable 22 becomes larger than a thickness of the plate material 221. Therefore, in a state where the plate material 221 is arranged and fixed in the recess portion 221a, it is restrained that the upper surface of the plate material 221 protrudes from the upper surface of the turntable 222, and it is restrained that: in case that a wood material W (FIG. 2) is arranged on the turntable 22, the wood material W is caught on the plate material 221.

Further, the screw 221A which fixes the plate material 221 is a so-called flat head screw, and a countersink into which the screw 221A is inserted is formed in the plate material 221 by machining. Accordingly, the head of the screw 221A caves in the surface of the plate material 221, whereby it is restrained that the head of the screw 221A protrudes from the plate material 221. Therefore, in case that the wood material W (FIG. 2) is arranged on the turntable 22, it is restrained that the wood material W is caught on the screw 221A.

As shown in FIG. 4, the plate material 222, similarly to the plate material 221, is arranged on a step part 222B in a recess portion 222a formed in the turntable 22, and fixed by the screws 222A. Since a distance from a contact surface of the step part 222B with the plate material 222 to the upper surface of the turntable 22 is larger than a thickness of the plate material 222, it is restrained that the wood material W is caught on the plate material 222. Further, the screw 222A is composed of a so-called flat head screw similarly to the screw 221A, and a countersink is formed in the plate material 222 by machining. Therefore, it is restrained that the head of the screw 222A protrudes from the plate material 222.

In a state where the plate material 221 is arranged and fixed in the recess portion 221a, a space 22b is formed between the plate material 221 and a bottom surface of the recess portion 221a. In a state where the plate material 222 is arranged and fixed in the recess portion 222a, a space 22c is formed between the plate material 222 and a bottom surface of the recess portion 222a. Since this space 22C has a degree of area, spare parts, for example, a brush of a motor driving a cutting blade 4 can be housed in the space 22c, whereby the spare parts can be provided quickly when necessary.

Regarding the space 22b, since its inside is not wide, the spare parts or the like cannot be housed in the space 22b. However, the portion on which the plate material 221 is arranged is a position in which the wood material W is placed, and which an operator is easiest to recognize visually in case that the wood material W is not placed. Therefore, by housing in this portion an attention note or an explanatory note on use of a product, operator's attention can be called, and safety of operation can be heightened.

As shown in FIG. 1, for the base portion 22B, a regulation operating part 27 is provided. The regulation operating part 27 is composed of a fixed handle 27A and a lock lever 27B. The fixed handle 27A functions as a grip when the turntable 22 is rotated, and can fix the turntable 22 at a predetermined rotary angle. The lock lever 27B is provided, extended mainly from the lower side of the fixed handle 27A and the lower side of the arcuate part 21C; and can fix the turntable 22 to the base 21 at the determined arbitrary angle.

The fence part 23 is provided on the base 21 and in the upper position of the turntable 22, and composed of a left fence 23A and a right fence 23B correspondingly to the left base 21A and the right base 21B. The front surface of the left fence 23A and the front surface of the right fence 23B are arranged so as to be located on the same plane.

Onto contact side surfaces of the left fence 23A and the right fence 23B with the wood material W (FIG. 2), as shown in FIG. 1, a plate material 231 and a plate material 232 are fixed and attached respectively by screws 231A and screws 232A. The plate material 231 and the plate material 232 are formed of the same material as the plate material 221 and the plate material 222. The plate material 231 and the plate material 232 are attached respectively to the left fence 23A and the right fence 23B with the similar constitution. Accordingly, in behalf of them, the constitution relating to the right fence 23B and the plate material 232 will be described.

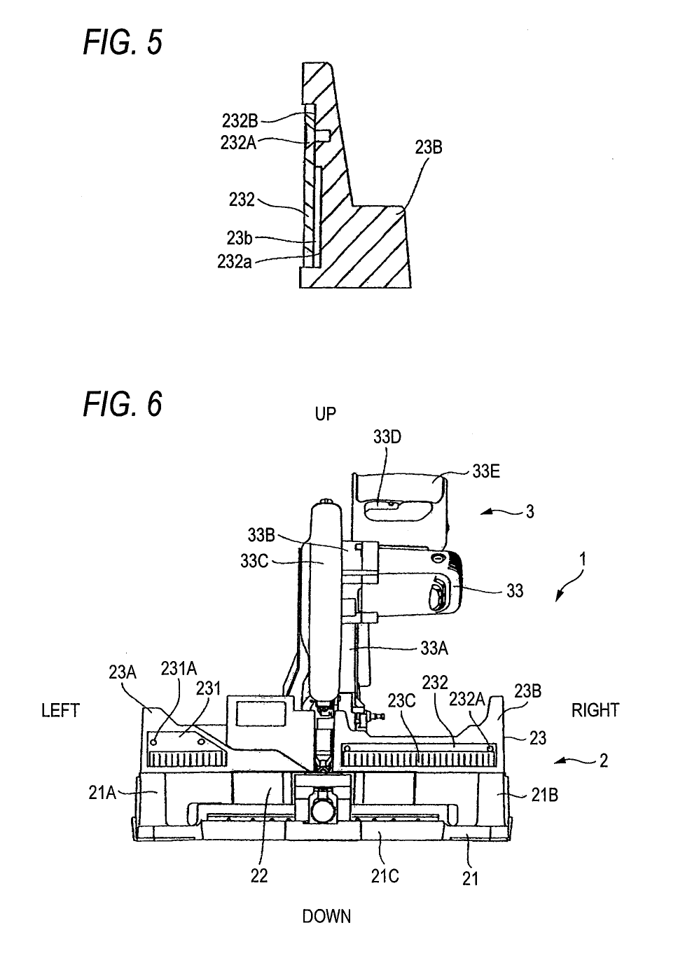

On the side surface of the right fence 23B to which the plate material 232 is to be fixed, as shown in FIG. 5, a recess portion 232a is formed, and the plate material 232 is arranged in the recess portion 232a.

A portion of the right fence 23B which defines the recess portion 232a is provided with a step part 232B in which a screw hole is formed, and the plate material 232 is arranged on this step part 232B and fixed by the screws 232A. The step part 232B is formed so that a distance from a contact surface of the step part 232B with the plate material 232 to the side surface of the right fence 23B becomes larger than a thickness of the plate material 232. Therefore, in a state where the plate material 232 is arranged and fixed in the recess portion 232a, it is restrained that the side surface of the plate material 232 protrudes from the side surface of the right fence 23B. Further, in case that the wood material W (FIG. 2) comes into contact with the side surface of the right fence 23B and positional specification of the wood material W is performed on the base part 2, it is restrained that the wood material W is caught on the plate material 232.

Further, the screw 232A which fixes the plate material 232 is a so-called flat head screw, and a countersink into which the screw 232A is inserted is formed in the plate material 232 by machining. Accordingly, the head of the screw 232A caves in the surface of the plate material 232, whereby it is restrained that the head of the screw 232A protrudes from the plate material 232. Therefore, in case that the wood material W (FIG. 2) comes into contact with the side surface of the left fence 23A and the positional specification of the wood material W is performed, it is restrained that the wood material W is caught on the screw 232A.

Further, in the state where the plate material 232 is arranged and fixed in the recess portion 232a, between the plate material 232 and a bottom surface of the recess portion 232a, a space 23b is formed. Accordingly, as shown in FIG. 6, a scale 23C having the predetermined scale divisions is housed in the space 23b, whereby the position of the wood material W can be specified without marking scale divisions on the side surface of the fence part 23 or the upper surface of the turntable 22.

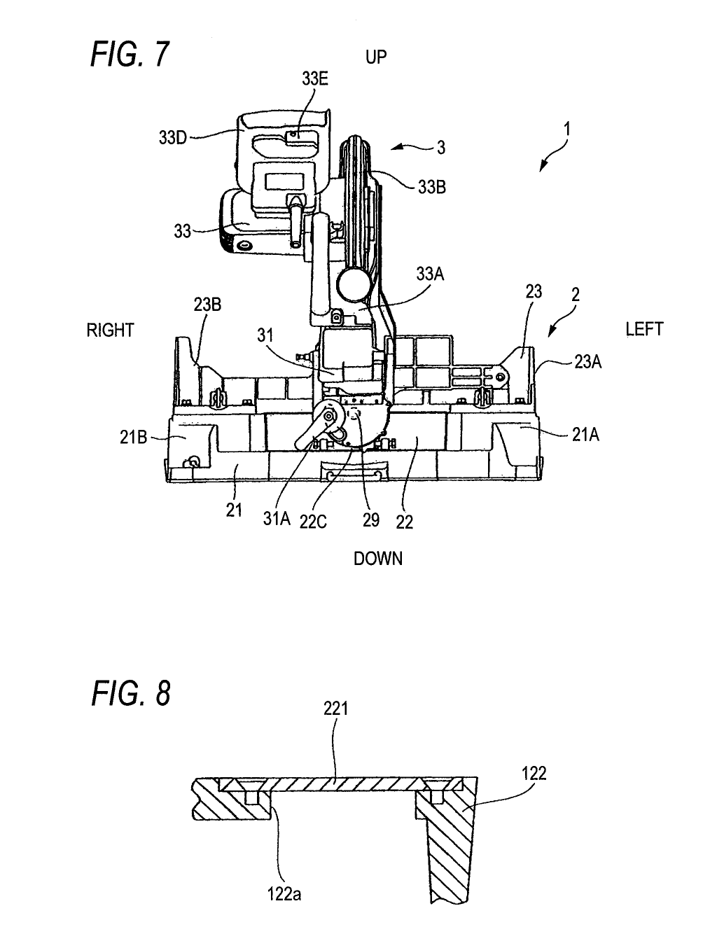

As shown in FIG. 1, the cutting part 3 is mainly composed of a tilt part 31, a swinging shaft part 32, and a cutting body part 33. As shown in FIG. 2, the tilt part 31 is tiltably connected through the tilt shaft part 29 to the cutting part supporting portion 22C. For the tilt part 31, a clamp lever 31A which screws to the cutting part supporting portion 22C is provided as shown in FIG. 7. By screwing forward the clamp lever 31A, the tilt part 31 and the cutting part supporting portion 22C are fixed thereby to set the cutting part 3 at the arbitrary tilt angle. As shown in FIG. 2, the swinging shaft part 32 is supported by the tilt part 31, and arranged so that its shaft is located nearly in the left and right direction.

The cutting body part 33 is mainly composed of a frame 33A, a housing 33B, a cover 33C, a handle 33D, a trigger 33E, and a cutting blade 4. The frame 33A is connected to the swinging shaft part 32, and constituted so that it can swing on the tilt part 31. The housing 33B is connected to the frame 33A, forms an outer casing of the cutting body part 33, and includes therein a motor and a gear which are not shown.

The cover 33C is constituted so that: when the cutting part 3 is located up, the cover 33C covers the cutting blade 4, and when the cutting part 3 is swung downward (toward the turntable 22), the cover 33C exposes the cutting blade to the outside.

The handle 33D is provided up of the housing 33B, and functions as a grip when the cutting part 3 is swung. The trigger 33E is provided for the handle 33D and controls drive of a not-shown motor.

The cutting blade 4 is rotation-driven by the not-shown motor, and arranged so that a part of the cutting blade 4 is inserted into the groove portion 22a in case that the cutting part 3 is swung downward.

In the thus constructed desk-top circular sawing machine 1, the fence part 23, the turntable 22, and the like are molded by casting aluminum as base material. Since the surface on which the wood material W is placed and the surface which regulates the position of the wood material W are formed after molding, the upper surface of the turntable 22 and the side surface of the fence part 23 are finished by grinding. In the aluminum casting time, a bubble is produced inside the vicinity of its surface. In case that the surfaces of the turntable 22 and the fence part 23 where this bubble is produced are shaved to form the upper surface and the side surface, there is a case where a hole-shaped casting defect, that is, a “cavity” is produced on the surface. In case that the wood material W is placed and moved on the upper surface in which the “cavity” is produced, the workpiece may be damaged by a sharp edge formed around the “cavity” and a dropped-out broken piece. However, by arranging the plate materials 221, 222, 231, and 232 on the surfaces with which the wood material W comes into contact, it is prevented that the surface of the aluminum base material in which the cavity may be produced comes into contact with the wood material W, so that it is possible to suppress occurrence of damage onto the wood material W caused by occurrence of the cavity.

Further, even if the cavity is produced in the turntable 22 or the like, as long as the position of the cavity is in the recess portion 221a or the recess portion 222a, a bad influence is not exerted on the wood material W. Accordingly, there is a case where even the turntable 22 in which the cavity has been produced can be used, so that yield in the manufacturing time can be improved.

Further, since the plate materials 221, 222, 231, and 232 are separate members from the turntable 22 and the fence part 23, in case that the plate material 221, 222, 231, or 232 has been damaged, only the damaged plate material should be exchanged.

Further, though aluminum is gradually oxidized with time and its color changes gradually to blackish color, in case that an acryl plate or a polycarbonate plate is used as the plate material, such the change of color and oxidization never occur. Even if such the plate is deteriorated, only the plate which has been deteriorated should be exchanged.

Further, since the plate materials 221, 222, 231, and 232 are formed of resin, it is lighter in specific gravity than aluminum. The turntable 22 body and the fence part 23 body are formed of aluminum, and their portions where the plate materials 221, 222, 231, and 232 are provided are not portions to which excessive stress is applied. Therefore, by using the plate materials 221, 222, 231, and 232, while keeping strength, weight reduction of the turntable 22 body and the fence part 23 can be realized.

As disclosed in the above embodiment, in a state shown in FIG. 1 which is high in frequency of use, it is desirable that the recess portions 221a, 222a and the plate materials 221, 222 are provided on the upper surface of the turntable 22 out of the vicinity of the lower end portion of the fence part 23. Hereby, even in case that the plate materials 221 and 222 are accommodated in the recess portions 221a and 222a so as not to protrude from the upper surface of the turntable 22 due to dimensional tolerance, the workpiece W can be guided by the upper surface of the turntable 22 near the lower end portion of the fence part 23. Therefore, it is possible to restrain workability from lowering.

Further, similarly, as disclosed in the above embodiment, in the state shown in FIG. 5, it is desirable that the recess portion 232a and the plate materials 231, 232 are provided on the side surface of the fence part 23 out of the vicinity of the upper surface of the turntable 22.

The desk-top cutting machine of the invention is not limited to the above-mentioned embodiment but various modification and improvements can be made within the scope as set out in the accompanying claims. For example, though the plate materials 221 and 22 are provided only on the turntable 22 in the embodiment, the invention is not limited to this, but a recess portion may be formed on the upper surface of the base 21 to accommodate the plate materials therein.

Further, as shown in FIG. 8, in the turntable 122, not the recess portion but a through-hole 122a extending from its upper surface to its lower surface may be provided. Further, this through-hole 122a may be covered with the plate material 221 to constitute a placement surface for the wood material W (FIG. 2). According to such the constitution, since at least the placement surface for the wood material W is constituted including the plate material 221, even in case that the cavity is produced in the turntable 122, it is restrained that the portion in which this cavity is produced comes into contact with the wood material W. Further, since the through-hole 122a is formed in the turntable 122, the weight of the desk-top circular sawing machine 1 including the turntable 122 can be reduced.

Further, in the embodiment, for example, in the turntable 22, as shown in FIGS. 3 and 4, the surface of the plate material 221, 222 caves in the upper surface of the turntable 22, and the surface of the plate material 221, 222 and the upper surface of the turntable 22 are not on the same plane. However, as long as the surface of the plate material 221, 222 does not protrude from the upper surface of the turntable, the surface of the plate material 221, 222 and the upper surface of the turntable 22 may be on the same plane. Also in such the constitution, it is restrained that the placed wood material W is caught on the plate material 221,222. Therefore, the operation can be appropriately performed.

Further, under the constitution in the embodiment, though the recess portions 221a, 222a and the plate materials 221, 222 having the portions arranged in the recess portions 221a, 222a are provided on the upper surface of the turntable 22, the plate material may be provided in the substantially whole area of the wood material placement surface of the turntable.

Further, the plate material and a throat plate may be formed of the same member. In this case, it is possible to provide a desk-top cutting machine which suppresses occurrence of the “cavity” to improve quality of a product while suppressing increase in the number of parts, and increases productivity.

What is claimed is:

1. A desk-top cutting machine comprising:
a base part capable of placing a workpiece on an upper surface thereof;
a fence part being provided on the base part, the fence part having a side surface for positioning the workpiece; and
a cutting part capable of swinging a cutting blade approachably to and separably from the base part, wherein a plate material is provided on at least one of the upper surface and the side surface, and
wherein the plate material is in a contactable position with the workpiece.

2. The desk-top cutting machine according to claim 1, wherein a recess portion is provided for at least one of the upper surface and the side surface, and the plate material has a portion arranged in the recess portion.

3. The desk-top cutting machine according to claim 2, comprising:
a step part being formed in the recess portion to come into contact with the plate material, wherein a distance from the contact portion of the step part with the plate material to the upper surface or the side surface is formed larger than a thickness of the plate material.

4. The desk-top cutting machine according to claim 3, wherein the plate material is fixed to the step part by a screw; and
wherein a head of the screw caves in a surface of the plate material.

5. The desk-top cutting machine according to claim 1, wherein the plate material is formed of a transparent material.
